(19) United States
(12) Patent Application Publication
(10) Pub. No.: US 2022/0125673 A1
(43) Pub. Date: Apr. 28, 2022

(54) MASSAGING TOOL

(71) Applicant: TENGA Co., Ltd., Tokyo (JP)

(72) Inventors: Hitoshi WATANABE, Tokyo (JP); Saya TAKEUCHI, Tokyo (JP); Tsutomu MATSUURA, Tokyo (JP)

(73) Assignee: TENGA Co., Ltd., Tokyo (JP)

(21) Appl. No.: 17/310,844

(22) PCT Filed: Mar. 15, 2019
(86) PCT No.: PCT/JP2019/010811

§ 371 Date: Aug. 26, 2021

(30) Foreign Application Priority Data
Mar. 6, 2019 (JP) 2019-040357

(51) Int. Cl. A61H 23/02

(52) U.S. Cl. CPC A61H 23/0263; A61H 2201/0157; A61H 2201/0153; A61H 2201/1215

(57) ABSTRACT

In a small massaging tool, numbness in fingers, strangeness, fatigue, and other discomfort, which are caused due to vibration of a grip part that is caused by vibration of a vibration motor, are eliminated to maintain comfortable use and vibration noise is reduced. The massaging tool includes a head unit 30 including vibrating parts 50 and 52 and a vibration motor 40 that vibrates the vibrating parts, a battery that is a power source of the vibration motor, and a body 10 having the vibration motor and the battery accommodated therein and having the grip part, wherein the head unit is supported in a floating state with respect to the body by a cushioning member made of gel-like resin and fixed to the body.

### FIELD

The present invention relates to a massaging tool that is suitable to locally massage a face, a head, a neck, and other sensitive body parts, is capable of efficiently reducing strangeness and discomfort such as numbness in a user's hand that is caused by vibration of a vibration motor, and is comfortable to use.

### BACKGROUND

There have been proposed various types of small massaging tools that are small enough to be gripped in one hand and that locally stimulate a body part such as acupressure points by vibration of a vibration motor to exhibit effects of improving blood flow and eliminating bodily waste and the like (Patent Literature 1, Patent Literature 2, Patent Literature 3).

Each of the massaging tools has a problem that vibration of a vibration motor is transmitted not only to a vibrating part that contacts skin but also to fingers via a grip part gripped by a user and thus discomfort such as numbness in fingers, strangeness, fatigue, or the like is caused to the user.

That is, the conventional massaging tools do not have a configuration with which comfortableness of use with fingers gripping a grip part is sufficiently considered. Therefore, there have been reports of complaints that, when users with weak finger skin and users who are sensitive to touch, as well as users with normal finger sensation, use a conventional massaging tool for a medium to long period of time, the users cannot bear the discomfort such as numbness in fingers so that they stop using the massaging tool, and then the users do not use the massaging tool any more although they have purchased one.

Further, there have been reports that uncomfortable vibration occurs due to resonance with the vibration frequency of a vibration motor to increase discomfort such as numbness in fingers and uncomfortable vibration noise occurs, depending on the material of a case constituting an outer shell and the assembly structure of other parts.

Therefore, it has been regarded that the conventional massaging tools are not suitable as means for efficiently massaging facial parts such as eyes, ears, temples, and the like, necks, and other sensitive body parts of not only persons with weak skin but also healthy persons for a long period of time.

Further, there is a problem that most of vibration energy that needs to be transmitted to a vibrating part from a vibration motor is distributed to a grip part, and thus the efficiency of the vibration motor is reduced and battery consumption is accelerated.

### CITATION LIST

### Patent Literatures

Patent Literature 1: Japanese Patent Application Laid-open No. 2004-358088

Patent Literature 2: Japanese Patent Application Laid-open No. 2008-264031

Patent Literature 3: Japanese Patent Application Laid-open No. 2010-88558

### SUMMARY

### Technical Problem

The present invention is to provide a technique for eliminating numbness in fingers, strangeness, fatigue, and other discomfort, which are caused to a user due to vibration of a grip part that is caused by vibration of a vibration motor, thereby maintaining comfortable use and reducing vibration noise in a massaging tool.

### Solution to Problem

In order to achieve the above object, a massaging tool according to the present invention comprises a head unit that includes a vibrating part and a vibration motor that vibrates the vibrating part, a battery that is a power source of the vibration motor, and a body that has the vibration motor and the battery accommodates therein and has a grip part, wherein the head unit is supported in a floating state with respect to the body by a cushioning member that is made of gel-like resin and fixed to the body.

### Advantageous Effects of Invention

According to the massaging tool of the present invention, it is possible to eliminate numbness in fingers, strangeness, fatigue, and other discomfort, which are caused to a user due to vibration of a grip part that is caused by vibration of a vibration motor, thereby maintaining comfortable use and reducing vibration noise.

### BRIEF DESCRIPTION OF DRAWINGS

FIGS. 1(a), 1(b), 1(c), 1(d), and 1(e) are respectively a front view, a right-side view, a top view, a bottom view, and a rear view illustrating an exterior configuration of a massaging tool according to an embodiment of the present invention, FIG. 1(f) is an exterior perspective view, FIG. 1(g) is a cross-sectional view taken along a line A-A illustrated in FIG. 1(a), and FIG. 1(h) is a cross-sectional view taken along a line B-B illustrated in FIG. 1(b).

FIGS. 2(a) and 2(b) are respectively a front view and a cross-sectional view taken along a line C-C illustrating a state where the massaging tool is covered with a cap.

FIG. 3 is an exploded perspective view illustrating each constituent part of the massaging tool according to the present invention.

FIG. 4 is an exploded perspective view illustrating a positional relation between a body, anti-vibration gel, and a head unit.

FIGS. 5(a) to 5(e) are respectively an exterior perspective view, a front view, a plan view, a bottom view, and a cross-sectional view taken along a line D-D illustrating a state where the head unit is supported by the anti-vibration gel.

FIGS. 6(a) to 6(f) are respectively a front view, a plan view, a bottom view, a vertical sectional view taken along a line E-E, a horizontal sectional view taken along a line F-F, and a sectional perspective view taken along the line F-F illustrating the anti-vibration gel.

FIGS. 7(a), 7(b), and 7(c) are respectively a perspective view illustrating a neutral state of the anti-vibration gel, a perspective view illustrating a clockwise twisted state of the anti-vibration gel, and a perspective view illustrating a counterclockwise twisted state of the anti-vibration gel.

### DESCRIPTION OF EMBODIMENTS

The present invention is described below in detail using embodiments illustrated in the drawings.

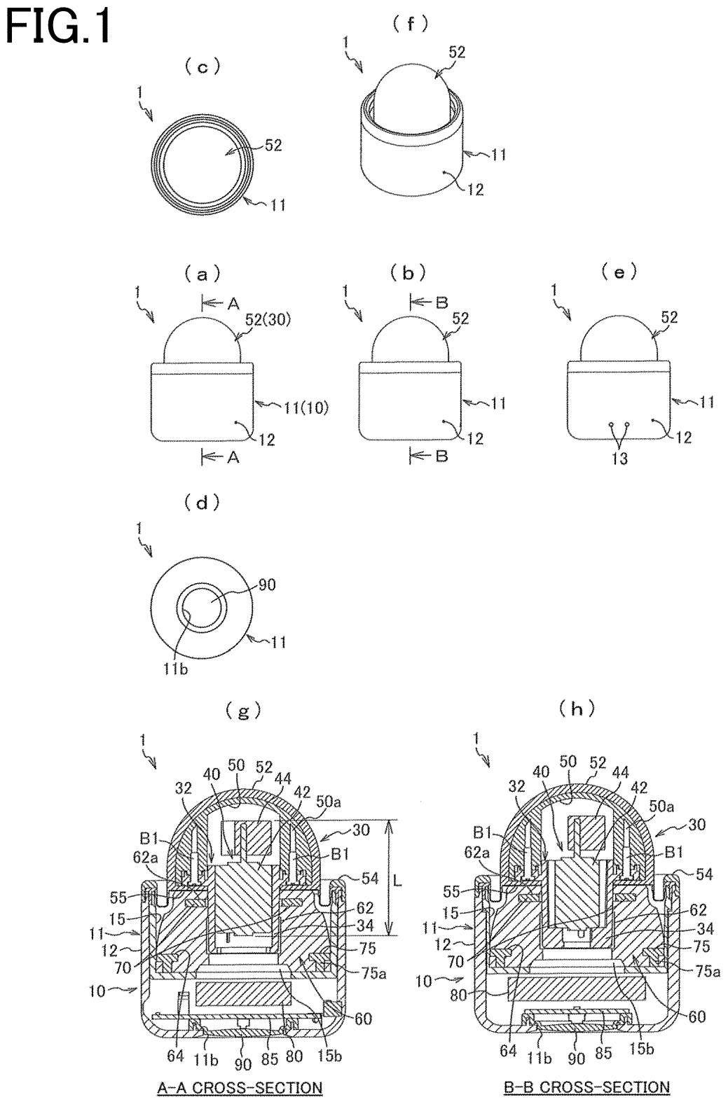

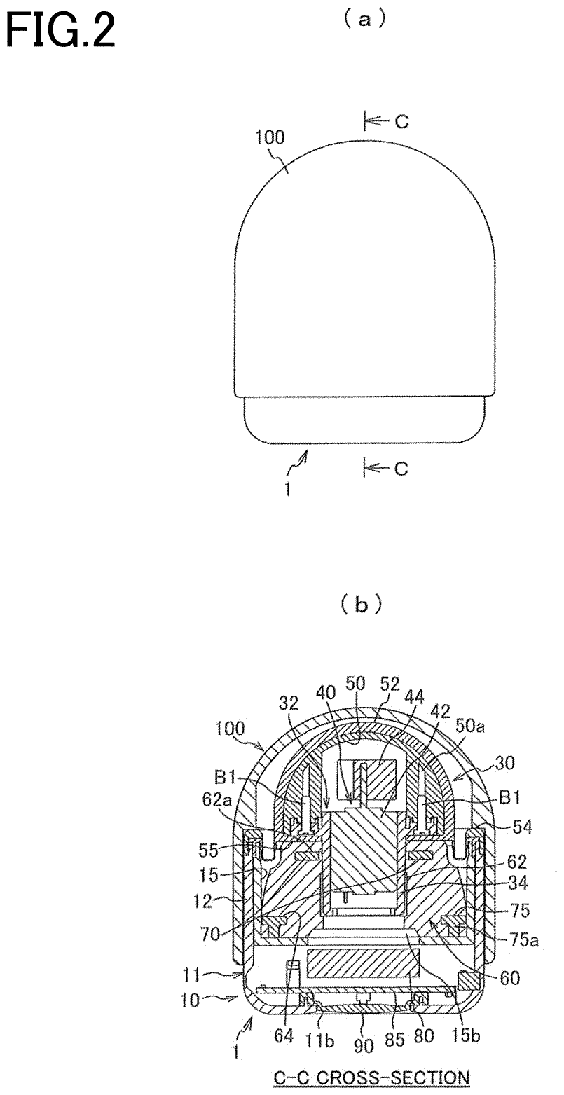

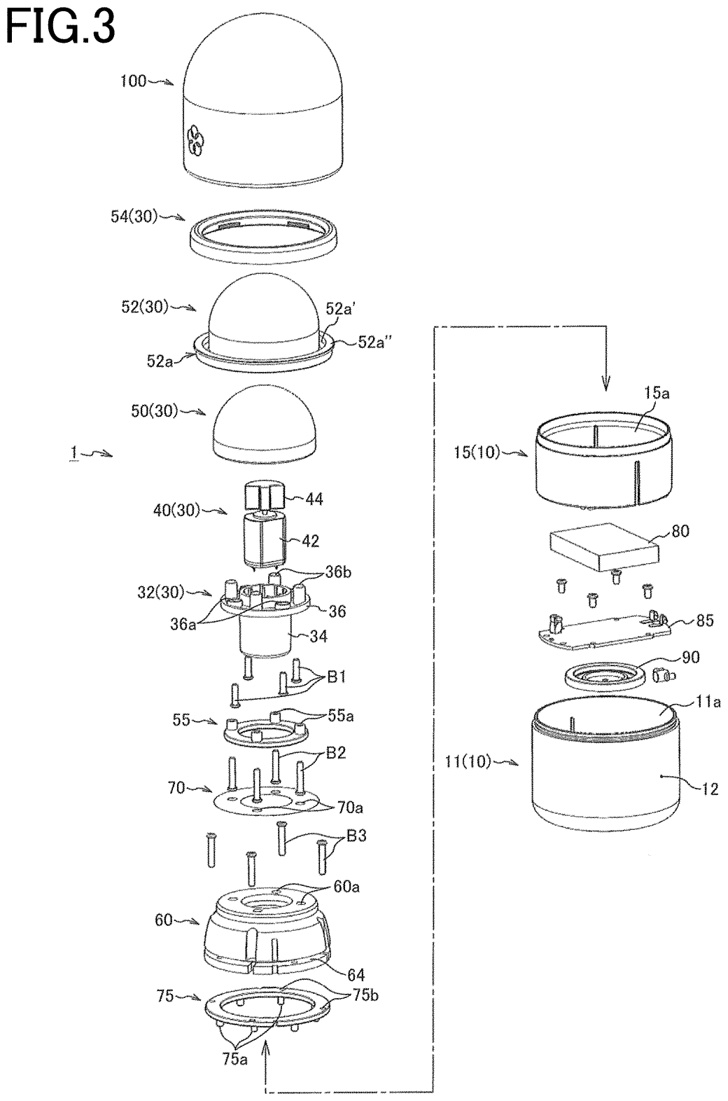

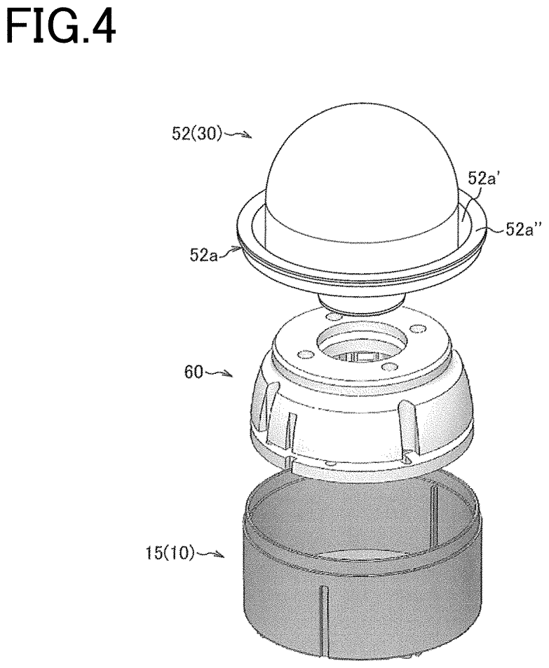

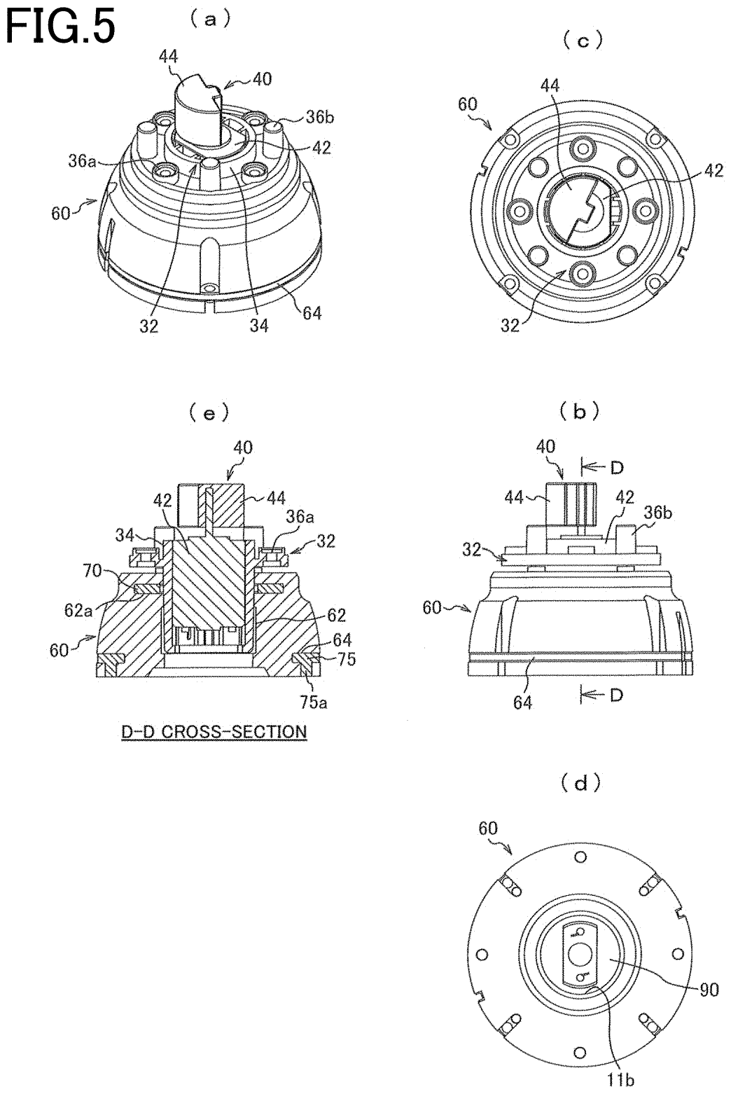

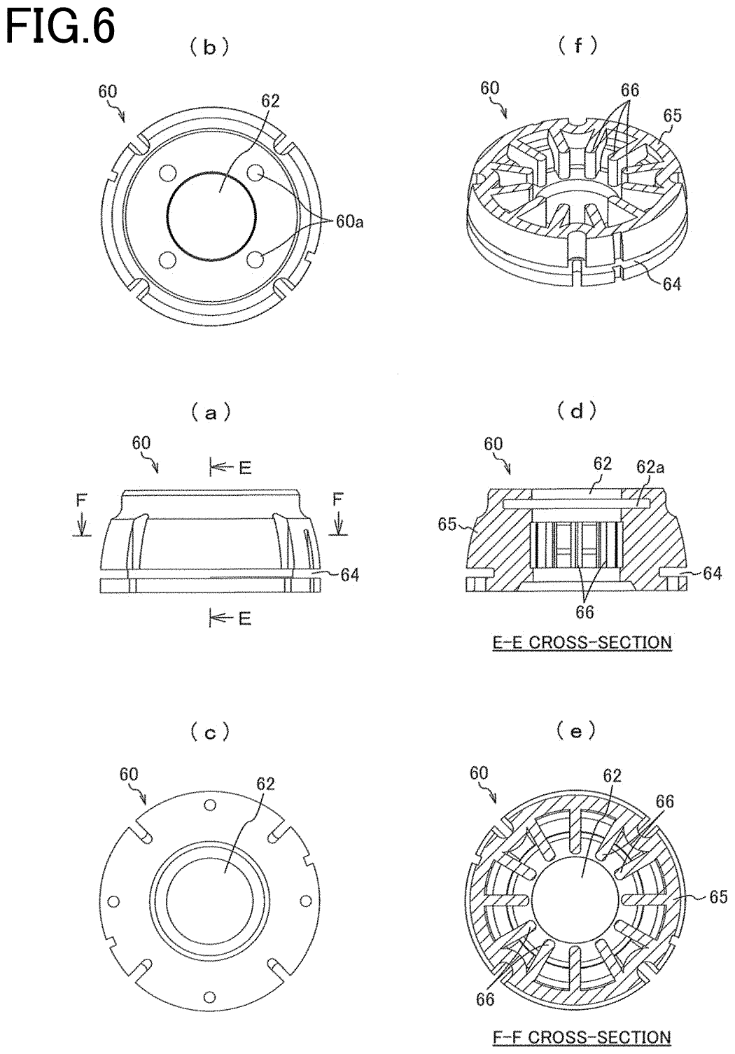

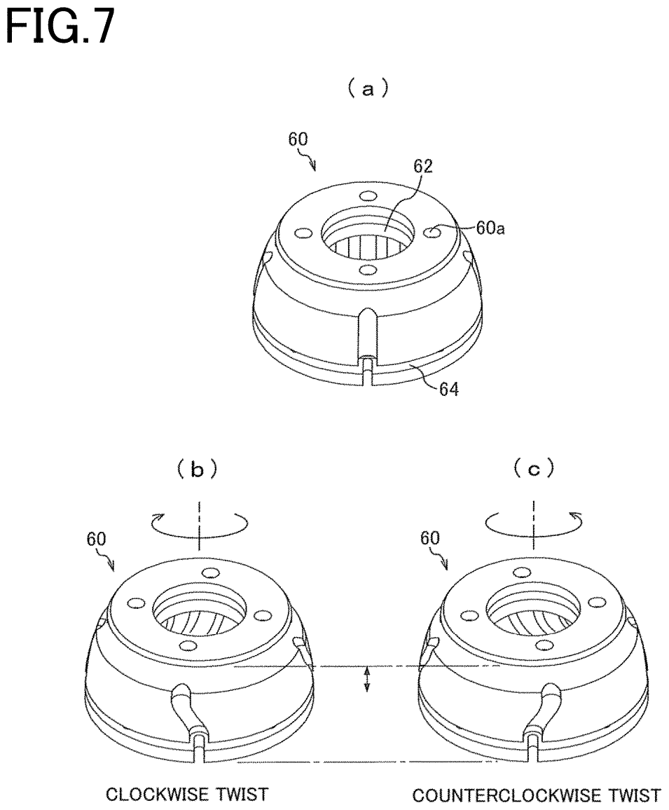

FIGS. 1(a), 1(b), 1(c), 1(d), and 1(e) are respectively a front view, a right-side view, a top view, a bottom view, and a rear view illustrating an exterior configuration of a massaging tool according to an embodiment of the present invention. FIG. 1(f) is an exterior perspective view, FIG. 1(g) is a cross-sectional view taken along a line A-A illustrated in FIG. 1(a), and FIG. 1(h) is a cross-sectional view taken along a line B-B illustrated in FIG. 1(b). FIGS. 2(a) and 2(b) are respectively a front view and a cross-sectional view taken along a line C-C illustrating a state where the massaging tool is covered with a cap. FIG. 3 is an exploded perspective view illustrating each constituent part of the massaging tool according to the present invention. FIG. 4 is an exploded perspective view illustrating a positional relation between a body, anti-vibration gel, and a head unit. FIGS. 5(a) to 5(e) are respectively an exterior perspective view, a front view, a plan view, a bottom view, and a cross-sectional view taken along a line D-D illustrating a state where the head unit is supported by the anti-vibration gel. FIGS. 6(a) to 6(f) are respectively a front view, a plan view, a bottom view, a vertical sectional view taken along a line E-E, a horizontal sectional view taken along a line F-F, and a sectional perspective view taken along the line F-F illustrating the anti-vibration gel. FIGS. 7(a), 7(b), and 7(c) are respectively a perspective view illustrating a neutral state of the anti-vibration gel, a perspective view illustrating a clockwise twisted state of the anti-vibration gel, and a perspective view illustrating a counterclockwise twisted state of the anti-vibration gel.

As illustrated in FIG. 1, a massaging tool 1 according to the present invention is characterized that it includes a body 10 having a grip part 12, and a head unit 30 having vibrating parts 50 and 52 and a vibration motor 40 that vibrates the vibrating parts, and has a configuration in which the head unit 30 is supported in a floating state by an anti-vibration gel (a cushioning member made of gel-like resin) 60 fixed to the body 10.

In other words, at least a part of the anti-vibration gel 60 is arranged in a transmission path for vibration directed to the body 10 (the grip part 12) from the vibration motor 40 and the vibrating parts 50 and 52 and attenuates or blocks vibration transmitted to the body 10 (the grip part 12) and causes most of vibration energy from the vibration motor to be efficiently transmitted to the vibrating parts 50 and 52. Further, by attenuating or blocking vibration energy directed to the body, it is possible to eliminate shaking of fingers gripping the grip part, reduction in the operability due to vibration, and discomfort such as numbness in fingers, and strangeness.

Reference sign 100 illustrated in FIGS. 2 and 3 represents a detachable cap that covers almost the entire massaging tool 1.

The configuration of the massaging tool 1 is described below in detail.

The massaging tool 1 is generally constituted of the body 10, the head unit 30, the anti-vibration gel (cushioning member) 60, a rechargeable battery 80, a printed board 85, a switching piece 90, and the like.

The body 10 includes an outer body piece 11 formed in a substantially cylindrical shape and having a large diameter and an inner body piece 15 formed in a substantially cylindrical shape and having a small diameter. An outer surface of the outer body piece 11 constitutes the grip part 12 that is gripped with fingers at the time of use by a user. An upper surface of the outer body piece 11 constitutes a large-diameter opening part 11a. A small-diameter opening part 11b in which the switching piece 90 is stored is formed in a central part of a lower surface of the outer body piece 11. A connector 13 to be connected to a charging cable terminal (not illustrated) is arranged at a lower part of the outer surface of the outer body piece and electrically connected to the battery 80.

The inner body piece 15 has a length shorter than that of the outer body piece 11 in an axial direction. An upper surface of the inner body piece 15 constitutes a large-diameter opening part 15a. A small-diameter opening part 15b through which a harness (not illustrated) that connects the battery, the printed board, and the motor to each other is inserted is formed in a central part of a lower surface of the inner body piece 15. Dimensions of an outer surface of the inner body piece are set in such a manner that the outer surface of the inner body piece is in close contact with and matches an inner surface of the outer body piece 11. The inner body piece 15 is fixed in such a manner that it is not displaced in the rotational direction and the vertical direction by a pressing ring 54 in a state where an upper edge of the inner body piece 15 is arranged at the same height position as an upper edge of the outer body piece 11.

The head unit 30 includes a head base 32 and the vibration motor 40. The head unit 30 is generally constituted of a dome-shaped head 50 made of hard resin having a lower opening part and covering the motor, a dome-shaped soft cover 52 made of soft resin such as silicon resin and having an inner surface in contact with an outer surface of the head 50, and the pressing ring 54 that fixes a flange part 52a to the upper outer-circumferential edges of the outer body piece 11 and the inner body piece 15. The flange part 52a protrudes from a circumferential edge of a lower opening part of the soft cover. The flange part 52a of the soft cover includes an inner annular recess 52′ and a flange 52a″ protruding to an outer circumference of the recess 52′. The flange 52a″ is provided on the upper outer-circumferential edges of the body pieces 11 and 15. Each of ring-shaped parts of the pressing ring 54 has an inverted-U-shaped vertical-sectional shape and is assembled so as to extend across and cover the upper outer-circumferential edges of the body pieces 11 and 15 via the flange 52a″ of the soft cover and fix the soft cover 52 to the body pieces.

Since the flange part 52a arranged at an outer circumferential part of the soft cover 52 is provided on the upper outer-circumferential edges of the body pieces 11 and 15, an anti-vibration/vibration-absorption function for preventing vibration of a dome-shaped part of the soft cover 52 as a vibrating part from being transmitted to the body pieces is exhibited.

In a state where the massaging tool 1 is assembled, the head 50 and the soft cover 52 that constitute the vibrating parts protrude upward from the upper opening edges of the body pieces 11 and 15 and the head base 32 is supported in a floating state by the anti-vibration gel 60, and thus the entire head unit 30 can be elastically ejected and retracted, inclined, and displaced due to the cushioning effect of the anti-vibration gel 60.

The head base 32 includes a hollow cylindrical part 34 that holds, on its inner bottom surface, the vibration motor 40 inserted from an upper opening of the head base 32 and accommodated in the head base 32 and prevents the vibration motor 40 from falling from the cylindrical part 34, and a flange 36 provided on an upper edge part of the cylindrical part. The flange 36 has formed therein a hole 36a for screwing to a screw hole of the bottom surface of the head 50 in a penetrating manner. That is, a screw hole 50a of the bottom part of the head 50 is fixed onto the flange 36 by screwing using a screw B1.

The vibration motor 40 includes a motor body 42 and a vibrating piece 44 that is fixed to an output shaft of the motor body. Vibration that occurs due to eccentric rotations of the vibrating piece causes the head 50 and the soft cover 52 to vibrate. Since the motor body 42 is accommodated in the cylindrical part 34 of the head base and then positioned and fixed, the vibration motor 40 reliably transmits vibration caused by the rotations of the vibrating piece 44 to the vibrating parts (the head 50 and the soft cover 52) via the head base. Further, the vibration transmitted from the vibration motor to the head 50 and the soft cover 52 is eliminated by the anti-vibration effect of the anti-vibration gel 60 and thus is not transmitted to the body.

A film-like and ring-shaped insulator sheet 55 is arranged and held under pressure between a lower surface of the flange 36 of the head base 32 and an upper surface of the anti-vibration gel 60 and prevents the flange part 52a of the soft cover 52 made of silicon resin from contacting an upper part of the anti-vibration gel. The soft cover 52 has a shape sufficient to cover the head 50 and the head base 32. When the insulator sheet 55 is not present, the upper surface of the anti-vibration gel directly contacts the lower surface of the soft cover. When the silicon resin forming the soft cover 52 contacts gel-like elastomer or soft urethane forming the anti-vibration gel, the silicon resin is swollen and degraded due to an oil component contained in the anti-vibration gel. Therefore, the insulator sheet 55 is interposed between the upper surface of the anti-vibration gel and the lower surface of the soft cover.

The anti-vibration gel (cushioning member) 60 is made of a super-soft resin material having high flexibility (low resilience), such as gel-like resin elastomer containing oil, super-soft urethane, or the like. Since the anti-vibration gel 60 has flexibility significantly higher than that of silicon rubber or the like used as the material of the soft cover 52, the anti-vibration gel is arranged between the vibration motor 40 as a vibration source and the vibrating parts and an inner circumferential wall (particularly the grip part 12) of the body 10 to be in contact with at least a part of the inner wall of the body, thereby maintaining high flexibility and cushioning property (anti-vibration property) of the anti-vibration gel 60, and it becomes possible to absorb and reduce vibration transmitted from the vibration motor (vibrating part) to the body (grip part).

In this example, screwing is made to fix the anti-vibration gel 60 to the body 10 and the head unit 30. That is, the anti-vibration gel includes, at its central part, a central hole (a hole for holding the head unit) 62 penetrating through the anti-vibration gel in the axial direction and is assembled to the head base in a state where the cylindrical part 34 of the head base 32 is elastically press-fitted in the central hole. A circular groove 62a is formed in an upper part of an inner wall of the central hole 62 of the anti-vibration gel 60 and extends around the inner wall. A small-diameter inner ring 70 made of hard resin is fitted into the circular groove in advance. Small holes 60a and 70a are formed at positions corresponding to the upper surface of the anti-vibration gel and the inner ring, respectively, and are coupled to and fixed to each other via screws B2. Further, distal ends of the screws B2 exceed the small holes 60a of the upper surface of the anti-vibration gel, pass through small holes 55a of the insulator sheet 55, and are screwed into screw holes 36b of the head base 32. That is, the screws B2 fix the anti-vibration gel to the head base 32 via the inner ring 70 and the insulator 55.

Next, a circular groove 64 is formed in a lower part of an outer circumferential surface of the anti-vibration gel 60 and extends around the outer circumferential surface of the anti-vibration gel 60. An outer ring 75 made of hard resin is fitted into the circular groove 64. Small protrusions 75a that function as spacers are arranged at a predetermined interval in a circumferential direction on a lower surface of the outer ring 75. The small protrusions 75a are in contact with an inner bottom surface of the inner body piece 15 in such a manner that the bottom surface of the anti-vibration gel 60 is positioned on the inner bottom surface of the inner body piece. Holes 75b are formed at a predetermined interval in the circumferential direction in the outer ring 75. By inserting screws B3 in the holes 75b to screw the outer ring 75 to the inner bottom surface of the inner body piece 15, a lower part of the anti-vibration gel is fixed to the inner bottom surface of the inner case. That is, the anti-vibration gel 60 elastically holds the cylindrical part 34 of the head base in the central hole 62 and is fixed to the head unit 30 via the inner ring 70 on its upper surface side and fixed to the inner bottom surface of the inner body piece via the outer ring 75 on its lower surface side. The outer circumferential surface (only the lower part in this example) of the anti-vibration gel 60 is in contact with an inner wall of the inner body piece. In other words, the anti-vibration gel 60 with the lower part fixed (locked) to the body 10 is fixed to the head unit 30 at the upper part, thereby supporting the head unit in a floating state. Even when the contact area of the anti-vibration gel and the body is reduced to zero or to a small area, vibration transmitted from the vibration motor as a vibration source and the vibrating parts to the body can be significantly attenuated or eliminated. However, even when the contact area of the anti-vibration gel and the body is increased, vibration from the vibration source is attenuated to a harmless degree by the attenuation effect of the anti-vibration gel before reaching the body. That is, while this is only an example, the anti-vibration gel 60 is in contact with the inner circumferential surface (the inner circumferential surface of the inner body piece) of the body only at the lower part in the axial direction in the example illustrated in the drawings. The contact area with the inner circumferential surface of the body may be zero or may be larger than that illustrated in the drawings.

Therefore, as the anti-vibration gel 60 twists and deforms in a rotational direction to absorb and reduce vibration and stress that occur in a rotational direction of the rotations of the vibration motor 40 and the vibrating parts 50 and 52 due to the rotations of the vibration motor 40 and the vibrating parts 50 and 52, it is possible to eliminate vibration transmitted to user's fingers gripping the grip part. FIGS. 7(b) and 7(c) illustrate a state where the anti-vibration gel is twisted right and left around the central axis of the anti-vibration gel. As the anti-vibration gel can be flexibly deformed in the rotational direction and the circumferential direction in this manner, the anti-vibration gel can efficiently absorb and reduce the stress in the rotational direction.

Since the anti-vibration gel 60 is integrated with the head unit 30 (vibrating parts), the anti-vibration gel 60 can efficiently absorb and reduce vibration caused by vibration of the vibration motor and the vibrating parts and transmitted in a direction different from the rotational direction, for example, vibration generated by the vibration motor and the vibrating parts and transmitted in the axial direction or other directions.

Further, as the anti-vibration gel 60 expands and contracts to be able to absorb and reduce stress that occurs in the axial direction due to the contact of the soft cover 52 constituting the vibrating part with a part (skin) to be massaged, it is possible to improve the cushioning property of the vibrating parts for the part to be massaged and allow comfortable use and comfortable contact.

Conventionally, there have been proposed various types of massaging tools in which a metal coil spring is arranged between a vibration motor and a bottom part of a body piece, thereby elastically receiving vibration generated by the vibration motor and transmitted in an axial direction. However, when a grip part (a grip part of an outer body piece) is present at a position in an outer diameter direction of the vibration motor or a vibrating part, it is difficult to sufficiently reduce vibration transmitted to the grip part 12 and it is not possible to eliminate discomfort such as numbness in fingers. When a cushioning member such as a coil spring or a plate spring is arranged between the vibration motor and the grip part to attenuate the vibration transmitted to the grip part positioned in the outer diameter direction of the vibration motor, there is a problem that the number of components increases, the structure becomes complex, and the size increases.

On the other hand, in a palm-sized small massaging tool, a grip part is positioned in an outer diameter direction of a vibration motor. Therefore, there is a strong demand of eliminating numbness in fingers that is caused by vibration transmitted to the grip part 12. However, it is difficult to eliminate vibration transmitted from the vibration motor to the grip part, depending on the type of cushioning member constituted by a coil spring.

Meanwhile, arranging a coil spring or a plate spring between the vibration motor and a bottom part of a body piece in a small massaging tool leads to an increase in the size of the massaging tool in the axial direction, so that it is preferable to avoid such a design choice.

Since the anti-vibration gel 60 according to the present invention supports, in the central hole 62, the cylindrical part 34 of the head base having the motor body 42 incorporated therein in a state where the cylindrical part 34 is movable, the anti-vibration gel 60 can elastically support the entire head unit 30 in a floating state with respect to the body. Therefore, the anti-vibration gel 60 absorbs and reduces not only vibration and displacement in the axial direction that are transmitted from the head unit 30 but also vibration and displacement in the outer diameter direction and vibration and displacement in a twisting direction, thereby preventing vibration and deformation from being transmitted to the body and significantly attenuating vibration and impact to fingers gripping the grip part 12.

As illustrated in each of the sectional views of FIGS. 6(e) and 6(f), the anti-vibration gel 60 is a hollow body that has, at its central part, the central hole 62 that penetrates through the anti-vibration gel 60 in the axial direction and in which the vibration motor is arranged, and has the outer circumferential surface facing (in contact with or not in contact with) the inner wall surface of the body. As illustrated in each of the sectional views, a plurality of ribs 66 protrude from an inner wall of an outer circumferential wall 65 toward the central part, and many voids formed between the ribs have a hollow structure and reduce the mass and the cost of an expensive gel-like resin material, while the shape and strength (shape retention) necessary as the cushioning member are maintained. Since there is a hollow structure, the anti-vibration gel 60 can be easily deformed in a twisting direction by pressure from the vibrating parts and can improve a cushioning effect of the vibrating parts that come into contact with skin.

Further, since the cylindrical part 34 of the head base having the motor body 42 incorporated therein is stored in the central hole 62 of the anti-vibration gel, the entire length of the massaging tool in the axial direction can be reduced.

Further, since the anti-vibration gel 60 is mainly positioned on the outer diameter side of the anti-vibration motor and is not interposed between the bottom part of the vibration motor and the inner bottom surface of the outer body piece (or the inner bottom surface of the inner body piece), it is possible to prevent an increase in the dimension of the massaging tool in the axial direction.

Even in a configuration in which a part of the anti-vibration gel is interposed (protrudes) between the bottom part of the vibration motor and the inner bottom surface of the outer body piece (or the inner bottom surface of the inner body piece), the performance to attenuate vibration transmitted to the grip part is not affected and thus it is not essential to have the anti-vibration gel positioned only on the outer diameter side of the anti-vibration motor.

When the position of the grip part 12 is on the outer diameter side of the vibration motor 40 as a vibration source and the vibrating parts and in a range of lengths of the vibration motor 40 and the vibrating parts in the axial direction, the effect of attenuating vibration transmitted to fingers gripping the grip part is highest. However, it is not essential that the grip part is positioned in a range of a length L (FIG. 1(g)) of the vibration source such as the vibration motor in the axial direction. That is, even when the body is long in the axial direction and the entire grip part or a part of the grip part is present under or above the range of the length L of the vibration motor in the axial direction, discomfort such as numbness may occur due to vibration transmitted to fingers from the vibration motor. Even in this case, the attenuation effect can be sufficiently exhibited by arranging the anti-vibration gel on the outer diameter side of the vibration motor and at other appropriate positions on the inner wall of the body.

Since the head unit 30 is held in a floating state by the anti-vibration gel 60, the head unit 30 can be displaced in any direction such as an axial direction, a diameter direction, or an inclination direction, enables the vibrating parts of the massaging tool gripped with fingers to contact a part to be massaged at any angle with any strength, and can improve the operability.

### Summary of Configurations, Actions, and Effects of the Present Invention

A massaging tool according to a first aspect of the present invention includes the head unit 30 having the vibrating parts 50 and 52 and the vibration motor 40 that vibrates the vibrating parts, the battery 80 that is a power source of the vibration motor, and the body 10 having the vibration motor and the battery accommodated therein and having a grip part on an outer surface, and the head unit is supported in a floating state (not in contact with the body) with respect to the body by the anti-vibration gel 60 made of gel-like resin and fixed to the body.

As for the type of conventional massaging tools including a vibrating part that is gripped with fingers and brought into contact with a part to be massaged, no measures have been taken to prevent vibration of a vibration motor from being transmitted from a grip part to fingers. There has been known using an elastic metal member such as a coil spring or a plate spring to add cushioning property to a vibrating part held by a body, but flexibility is limited in this case and it is not possible to prevent vibration from being transmitted to a grip part (no function of attenuating vibration).

In the present invention, the cushioning member made of a gel-like resin material having high flexibility is used to provide cushioning property to the vibrating parts and used for prevention of vibration to the grip part and for cushioning (as a damper).

When the body is long and the grip part is sufficiently separated from the vibration motor as a vibration source and the vibrating parts, problems such as numbness in fingers hardly occur. However, conventionally, when the body is short and the grip part is close to the vibrating part, the vibration motor, and the like, vibration from the vibration motor and the like directly causes the grip part to vibrate. In order to avoid this situation, in the present invention, since a cushioning member made of a gel-like resin material having high flexibility to block vibration transmission is arranged between the vibration motor and the vibrating parts and the grip part to be gripped by a user and is present in a range in which vibration from the vibration motor and the vibrating parts is transmitted, numbness in fingers, strangeness, fatigue, and other discomfort that are caused to a user can be eliminated to maintain comfortable use, and vibration noise can be reduced.

Further, since a gel-like resin material having high flexibility that a metal coil spring and a metal plate spring do not achieve is used, it is possible to softly adjust pressure when the vibrating parts contact skin and give vibration thereto, and it is possible to improve comfortableness of use. Particularly, it is possible to exhibit the original massaging effects of improving blood flow, eliminating bodily waste, recovering from fatigue, and the like without causing any damage on sensitive affected parts and skin.

In a massaging tool according to a second aspect of the present invention, at least a part of the cushioning member 60 is arranged between the vibration motor 40 and the grip part 12.

In the massaging tool in which the grip part is positioned on the outer diameter side of the vibration motor, the cushioning effect can be improved by arranging at least a part of the cushioning member at a position in the outer diameter direction of the vibration motor, particularly between the vibration motor and the grip part. Vibration from the vibration motor is transmitted in various directions via the member in contact with the vibration motor. However, when the vibration motor is supported in a floating state in the cushioning member, it is possible to efficiently attenuate vibration and prevent the vibration from reaching the body by arranging the cushioning member to come in contact with the vibration motor mainly in the range of the length L of the vibration motor in the axial direction.

In this case, the cushioning member does not need to cover the entire length of the vibration motor in the axial direction, and vibration can be attenuated when the cushioning member has, in the axial direction, a length sufficient to cover at least a part of the vibration motor.

When at least a part of the cushioning member 60 is arranged “between the vibration motor 40 and the grip part 12”, it includes a case where the grip part is positioned in the range of the length L of the vibration motor in the axial direction or out of the range of the length L of the vibration motor in the axial direction. That is, it includes a case where the grip part is present in the outer diameter direction out of the range of the length L of the vibration motor in the axial direction.

In a massaging tool according to a third aspect of the present invention, at least a part of the grip part is positioned in the range of the length L of the vibration motor in the axial direction.

In a small massaging tool in which a grip part is present in a range of the length L of the vibration motor in an axial direction, when any cushioning member is not present between the vibration motor and the grip part, vibration of the grip part is intolerable.

According to the present invention, since the vibration motor is supported in a hung state (a floating state, a state of not being in contact with the body) by the cushioning member supported by the body, it is possible to attenuate vibration transmitted from the vibration motor to the body, regardless of a positional relation of the grip part with respect to the vibration motor and a distance from the grip part to the vibration motor. Particularly, by applying a structure in which the vibration source is held by the cushioning member of the present invention to a small massaging tool in which at least a part of the grip part is positioned in the range of the length L of the vibration motor in the axial direction, it is possible to efficiently attenuate vibration and prevent the vibration from reaching the body.

In a massaging tool according to a fourth aspect of the present invention, the cushioning member 60 has, at the central part, the central hole 62 that penetrates through the cushioning member 60 in the axial direction and in which the vibration motor 40 is arranged, and has the outer circumferential surface facing (in contact with or not in contact with) the inner wall surface of the body.

Since the vibration motor is arranged in a range of the length of the cushioning member 60 in the axial direction, the entire length of the massaging tool can be shortened.

Since the cushioning member 60 has a function of preventing vibration from the vibration motor and the vibrating parts from being transmitted to the grip part, it suffices that the cushioning member 60 is arranged in a transmission path of vibration and exhibits the attenuation function, and thus the outer circumferential surface of the cushioning member does not need to be in contact with the inner wall of the body.

Since the inside of the cushioning member is hollow, the mass is made small while required shape retention is maintained, and the cost of the material can be reduced. Further, the cushioning member can twist and deform due to the presence of the hollow, thereby attenuating stress in the rotational direction that is received from a vibration source.

### REFERENCE SIGNS LIST

1 massaging tool, 10 body, 11 outer body piece, 11a opening part, 11b opening part, 12 grip part, 13 connector, 15 inner body piece, 15a opening part, 15b opening part, 30 head unit, 32 head base, 34 cylindrical part, 36 flange, 36a hole, 36b screw hole, 40 vibration motor, 42 motor body, 44 vibrating piece, 50 head, 50a screw hole, 52 soft cover, 52a flange part, 54 pressing ring, 55 insulator sheet, 55a small hole, 60 cushioning member (anti-vibration gel), 60a small hole, 62 central hole, 62a circular groove, 64 circular groove, 70 inner ring, 75 outer ring, 75a protrusion, 75b hole, 80 battery, 85 printed board, 90 switching piece.

1. A massaging tool comprising:
a head unit that includes a vibrating part and a vibration motor that vibrates the vibrating part;
a battery that is a power source of the vibration motor; and
a body that has the vibration motor and the battery accommodated therein and has a grip part, wherein
the head unit is supported in a floating state with respect to the body by a cushioning member that is made of gel-like resin and fixed to the body.

2. The massaging tool according to claim 1, wherein at least a part of the cushioning member is arranged between the vibration motor and the grip part.

3. The massaging tool according to claim 2, wherein at least a part of the grip part is positioned in a range of a length of the vibration motor in an axial direction.

4. The massaging tool according to claim 2, wherein the cushioning member has, at a central part, a central hole that penetrates through the cushioning member in the axial direction and in which the vibration motor is arranged, and has an outer circumferential surface facing an inner wall surface of the body.
